(19) United States
(12) Patent Application Publication
(10) Pub. No.: US 2026/0172870 A1
(43) Pub. Date: Jun. 18, 2026

(54) METHODS FOR REPORTING ENERGY EVENTS

(71) Applicant: Samsung Electronics Co., Ltd., Suwon-si, Gyeonggi-do (KR)

(72) Inventors: Erik GUTTMAN, Chertsey (GB); Chadi KHIRALLAH, Chertsey (GB); Mahmoud WATFA, Chertsey (GB)

(21) Appl. No.: 19/126,888

(22) PCT Filed: Oct. 31, 2023
(86) PCT No.: PCT/KR2023/017151

§ 371 Date: May 2, 2025

(30) Foreign Application Priority Data
Nov. 4, 2022 (GB) 2216410.7
Oct. 3, 2023 (GB) 2315130.1
Oct. 26, 2023 (GB) 2316426.2

(51) Int. Cl. H04W 24/10; H02J 7/40; H04L 12/14

(52) U.S. Cl. CPC H04W 24/10; H02J 7/40; H04L 12/14

(57) ABSTRACT

The disclosure relates to a 5G or 6G communication system for supporting a higher data transmission rate. A method, performed by a Policy Charging Function (PCF), comprising: transmitting, to a Session Management Function (SMF), an energy policy related to energy credit controlling, receiving, from the SMF, an event notification; and, transmitting, to an Application Function (AF), the event notification, wherein the policy is transmitted from the PCF to Online Charging System (OCS) via the SMF, wherein the event notification is triggered at the OCS and transmitted from the OCS to the PCF via the SMF in case that the OCS identifies AMF SMF that the policy includes energy control policy and aggregate energy cost is larger than energy credit limit based on the policy.

### TECHNICAL FIELD

The present application relates to the reporting energy events and, more specifically relates to a method for reporting event notification to Application Function (AF) and a computer-readable storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Solution to Problem

A method, performed by a Policy Charging Function (PCF), comprising: transmitting, to a Session Management Function (SMF), an energy policy related to energy credit controlling, receiving, from the SMF, an event notification; and, transmitting, to an Application Function (AF), the event notification, wherein the policy is transmitted from the PCF to Online Charging System (OCS) via the SMF, wherein the event notification is triggered at the OCS and transmitted from the OCS to the PCF via the SMF in case that the OCS identifies that the policy includes energy control policy and aggregate energy cost is larger than energy credit limit based on the policy.

A method, performed by a Policy Charging Function (PCF), comprising: receiving, from an Application Function (AF), a request message related to monitoring of energy usage; monitoring the energy usage based on an energy policy; transmitting, to an Online Charging Function (OCF) and a Session Management Function (SMF), a monitoring information related to the energy usage; receiving, from the SMF, an energy usage information; and transmitting, to the AF, an event notification based on the energy usage information; wherein the energy usage information is transmitted from the OCS to the PCF via the SMF based on the energy policy.

To further clarify advantages and features of the disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

For a better understanding of the invention, and to show how exemplary embodiments of the same may be brought into effect, reference will be made, by way of example only, to the accompanying diagrammatic Figures, in which:

FIG. 1 is a schematic diagram of charging and credit control in 5G networks according to an embodiment of the disclosure.

FIG. 2 is a schematic diagram of monitoring for sponsored connectivity in 5G networks according to an embodiment of the disclosure.

FIG. 3 is a schematic diagram of energy credit control and reporting according to an embodiment of the disclosure.

FIG. 4 is a schematic diagram of network reporting energy utilization to AF according to an embodiment of the disclosure.

FIG. 5 is a schematic diagram of network reporting energy utilization to AF according to an embodiment of the disclosure.

FIG. 6 is a schematic diagram of monitoring of energy events by the 5G network for an AS according to an embodiment of the disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Exemplary embodiments of the present disclosure are further described below with reference to the accompanying drawings.

The text and drawings are provided as examples only to help readers understand the present disclosure. They are not intended and should not be understood as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

The term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

According to an embodiment of the disclosure, based on policy, trigger gating control in the User Plane Function (UPF) based on ‘too much use of energy.’ This is a new form of credit control—‘energy credit control’ (parallels the use of credit control in the 5G system, but new), and will trigger the 5G system to report this control event to the Application Function (AF). (Again ‘out of credit’ is an event that is already supported in the standard, that is exposed to the AF. Now the additional event is defined: ‘out of allowed energy use.’)

According to an embodiment of the disclosure, the Session Management Function (SMF) in the existing standard is able to report usage (time, volume) to the Policy Charging Function (PCF). In the case of ‘sponsored connectivity, the PCF can signal the usage information to the AF [since the AF/service provider is charged not the subscriber!] In this new mechanism:
a. The SMF is able to gather ‘energy utilization information’. The means for this is not defined in the disclosure, but could be via 3GPP OAM standards defined energy consumption monitoring functions, new energy consumption an enablers for network automation (eNA) analytics 3GPP TS 23.288, Network Data Analytics Service (NWDAF), through the charging system or some other means. No attempt is made to describe a new ‘control plane solution’ for gathering energy utilization.
b. In the context of the disclosure, the SMF can report energy usage info to the PCF. The PCF can use the same kind of signaling as for data service usage reporting for sponsored connectivity to the AF. The control for this (whether to do it or not, at what thresholds, etc.) will be defined by policy and not described in any further detail.
c. In order to provide the AF with the same energy use information as would be used for ‘gating’, a new form of credit usage monitoring is added from the Online Charging Server/System (OCS) to the SMF.

A new use case that defined an Energy policy to provide a maximum energy utilization rate, was included in the study on Energy service (FS_EnergyServe, SP-230235 “Study on Energy Efficiency as service criteria”) and subsequently added to the normative requirements for 5G as part of the EnergyServ feature, SP-230520 “Energy Efficiency as a service criteria”. This energy policy may be applied to best effort traffic (or equally and/or with further modification to other type of traffic).

The agreed new use case proposed a new traffic class ‘best effort with associated energy policy’ that could be enforced by the network (an external/internal entity and/or function) and/or Application function (AF). An embodiment of the disclosure supports both this class of traffic, or any other class of traffic or service.

The 3GPP standard does not define support for perform energy utilization monitoring and enforcement based on energy policy. Moreover, whether this monitoring and enforcement would include interaction between the network and an AF is suggested but not described in TR 22.882.

Currently in the 3GPP standard, there is a mechanism that supports interaction between the 5G network and an AF to establish and control service sessions. The framework supports the following functions:
Establishing and terminating sessions;
Associating traffic;
Notifications from the 5G network to the AF of certain events, e.g. when a requested Quality of Service (QOS) policy cannot be applied.

The 5G policy and charging control standard is specified in TS 23.503. This concerns policies (Policy Charging Control rules, PCC rules) that are linked to QoS Flows.

However, all of above functions only take into account QoS policy but not the newly defined Energy policy.

An embodiment of the disclosure proposes solutions to support new functions for energy event notification, acquisition and enforcement of energy utilization based on a defined energy policy. For example, the invention may relate to a method of and apparatus for reporting energy events to the Application Function.

An embodiment of the disclosure provides solutions to support the following newly defined functionalities:
1. Event Notifications by the 5G network to AF, to inform of energy policy related events, as well as energy utilization monitoring events relevant to the energy policy.
2. Energy Utilization Enforcement of a defined energy policy.
3. Energy Utilization Acquisition of energy utilization information from the 5G system, to enable enforcement of the defined energy policy.

More specifically, an embodiment of the disclosure introduces the following:
1) A new set of rules and policies: For example, new specific rules to support actions determined by a defined energy policy.

These policies are not an alternative to the existing mechanisms of policy interaction, since it is still necessary to identify for a given session what traffic flows are associated with a given service by an AF. The energy policy and associated rules will be in addition to the existing functions, providing additional potential control opportunities for the service provider (the party that operates the AF).
2) A new set of trigger events and monitoring policy: To support energy utilization events according to the needs of the AF.

Similarly to 1, this will not replace the existing PCC monitoring facilities. It will add to the existing functions.
3) A set of mechanisms will be added (as alternatives) to enforce energy policy.
4) A set of mechanisms will be added (as alternatives) to acquire ‘energy utilization’ information—this information is what the energy policy and monitoring triggers refer to.

An embodiment of the disclosure introduces a new set of rules for energy utilization and energy policy that can be enforced by the 5GS.

Particularly, an embodiment of the disclosure defines how the energy policy can be defined so that it includes sending monitoring information from the SMF to the PCF and from the PCF to an AF, and to determine enforcement including increased charging or ‘gating’ as a new form of credit control, rather than, for example, a policy ‘associated with a subscriber's subscription data’ so that this would establish a maximum energy utilization rate.

### Study on Energy Efficiency as Service Criteria

This is a study item in SA1 that has a breadth of scope to cover new uses of energy efficiency from a service perspective-including the use of energy performance and energy performance policy (SP-230235 “Study on Energy Efficiency as service criteria”).

This study is aiming at identifying use cases, providing gap analysis and defining potential requirements in the following aspects regarding enhancement on energy efficiency of 5G network.

The objectives include:
Define and support energy efficiency criteria as part of communication service to user and application services.
Support information exposure on systematic energy consumption or level of energy efficiency to vertical customers.
Gap analysis between the identified potential requirements and existing 5GS requirements or functionalities.
Other aspects include security, charging and privacy.

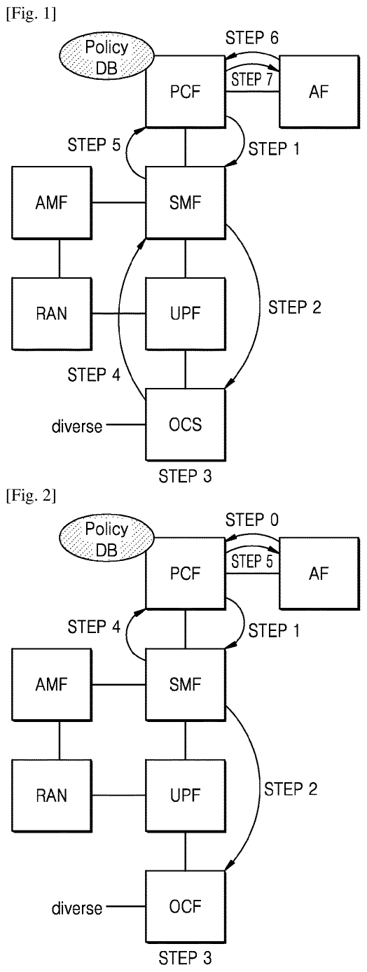

FIG. 1 is a schematic diagram of charging and credit control in 5G networks according to an embodiment of the disclosure.
Step 1: According to an embodiment of the disclosure, the Policy Charging Function (PCF) sends to Session Management Function (SMF) the policy. The policy may include at least one of credit limits or out of credit event trigger parameters but not limited to.
Step 2: According to an embodiment of the disclosure, the SMF forwards the policy to Online Charging Server/System (OCS).
Step 3: According to an embodiment of the disclosure, if there is a credit control policy, the OCS takes charging events and multiplies them by ‘cost policy’, as per Policy Charging Control (PCC) rule. When the aggregate cost>credit limit, OCS triggers an ‘Out of Credit’ event notification.
Step 4: According to an embodiment of the disclosure, the OCS sends ‘Out of Credit’ event triggers to SMF for enforcement. For example, the SMF may gate the sessions (informs UPF to stop routing traffic, limit service to a reduced level, etc.)
Step 5: According to an embodiment of the disclosure, the SMF sends ‘Out of Credit’ event triggers to PCF for action. The action may include notifying, to Application Function (AF), notification but not limited to.
Step 6: According to an embodiment of the disclosure, the AF may send to the PCF the AF Requests notification on ‘Out of Credit’events (if not previously requested).
Step 7: According to an embodiment of the disclosure, the PCF sends the ‘Out of Credit’ notification to the AF.

FIG. 2 is a schematic diagram of monitoring for sponsored connectivity in 5G networks according to an embodiment of the disclosure.
Step 0: [In advance] According to an embodiment of the disclosure, the AF establishes the PCF of the sponsorship for a session, including a usage threshold and whether the PCF reports events to the AF.
Step 1 and Step 2: According to an embodiment of the disclosure, the PCF determines the usage monitoring based on the Policy included in the PCF. According to an embodiment of the disclosure, the PCF respectively distribute the determined usage monitoring to the SMF and Offline Charging Function (OCF). This can be at the level of the service data flow. This is described in 3GPP TS 23.501, “System architecture for the 5G System (5GS)”,
Step 3: According to an embodiment of the disclosure, the chargeable events are stored in the offline charging repository included in the OCF.
Step 4: According to an embodiment of the disclosure, the SMF reports usage information to the PCF.
Step 5: According to an embodiment of the disclosure, the PCF may take action. The action may include notify to the AF the notification, but not limited to.

Note that normal AFs cannot request user monitoring information. This is specific to sponsored connectivity.

### Solution 1: Energy Credit Control and Reporting

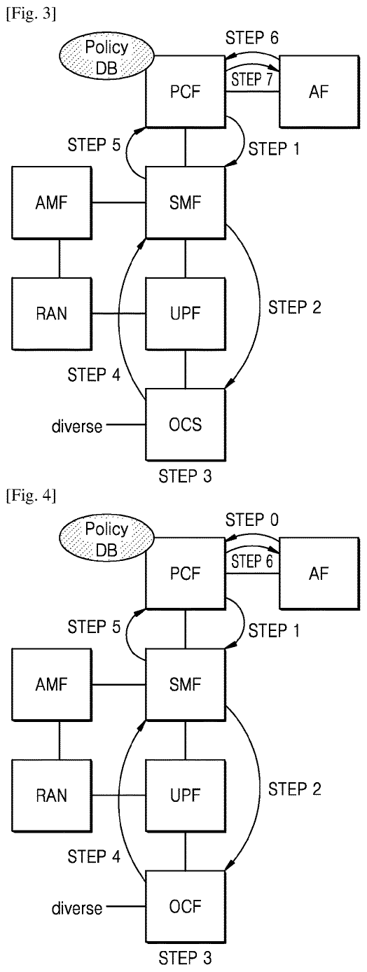

FIG. 3 is a schematic diagram of energy credit control and reporting according to an embodiment of the disclosure.
Step 1: According to an embodiment of the disclosure, the PCF sends to SMF the policy. The policy may include at least one of Energy charging, energy credit limits and Out of Energy Credit event trigger parameters, but not limited to.
Step 2: According to an embodiment of the disclosure, the SMF forwards the policy to OCS.
Step 3: According to an embodiment of the disclosure, if there is a defined energy control policy, the OCS takes charging events and multiplies them by ‘energy rating policy’, as per PCC rule. When the aggregate energy cost>energy credit limit, OCS triggers an ‘Out of Energy Credit’event notification.
Step 4: According to an embodiment of the disclosure, the OCS sends ‘Out of Energy Credit’ event notifications/triggers to SMF for enforcement. For example, the SMF may gate the sessions (informs UPF to stop routing traffic, reduce traffic performance to a low maximum bit rate, etc.)
Step 5: According to an embodiment of the disclosure, the SMF sends ‘Out of Energy Credit’ event triggers to PCF for action (e.g. AF notification).
Step 6: According to an embodiment of the disclosure, the AF may request, to the PCF, the AF requests notification on ‘Out of Energy Credit’ events (if not previously requested).
Step 7: According to an embodiment of the disclosure, the PCF sends the ‘Out of Energy Credit’ events notification to the AF.

An ‘energy cost’ is assigned to each chargeable event, which is passed to the OCS. Note that ‘rating and charging’ are defined in different 3GPP technical specifications (3 32.255 “Telecommunication management; Charging management; 5G data connectivity domain charging; Stage 2”) and this disclosure goes into no further detail except to state that the energy cost corresponding to ‘energy credit’ is determined in OCS based on ‘rating policy’available there. [this may not come from the PCF].

### Solution 2 (Alt-1): Network Reporting Energy Utilization to AF

FIG. 4 is a schematic diagram of network reporting energy utilization to AF according to an embodiment of the disclosure.
Step 0:[In advance] According to an embodiment of the disclosure, the AF requests, to the PCF, monitoring of ‘energy usage events’ being used in the case that the PCF establish an energy usage threshold and this policy allows the PCF to report events to the AF.
Step 1 and Step 2: According to an embodiment of the disclosure, the PCF determines the energy usage monitoring based on the Policy included in the PCF.

According to an embodiment of the disclosure, the PCF respectively distribute the energy usage monitoring to the SMF and OCF.
Step 3: According to an embodiment of the disclosure, the chargeable events are stored in the offline charging repository. In addition to other events, the energy charging consequences are also recorded as accounting data (for future correlation, etc.)
Step 4: According to an embodiment of the disclosure, the OCF reports the energy usage information to the SMF based on a policy.
Step 5: According to an embodiment of the disclosure, the SMF reports the energy usage information to the PCF.
Step 6: According to an embodiment of the disclosure, the PCF may take an action (e.g. AF notification of energy usage event, or other energy usage, monitoring and/or enforcement related events, but not limited to).

### Solution 2 (Alt-2): Network Reporting Energy Utilization to AF

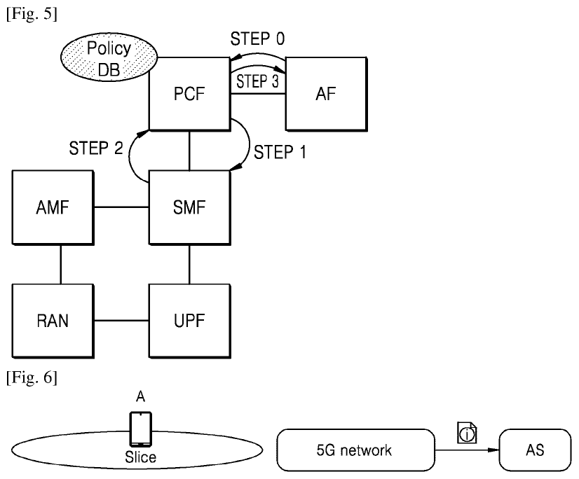

FIG. 5 is a schematic diagram of network reporting energy utilization to AF according to an embodiment of the disclosure
Step 0: [In advance] According to an embodiment of the disclosure, the AF requests to the PCF to provide energy utilization notifications (event reports) corresponding to an established energy usage threshold and report events to the AF.
Step 1: According to an embodiment of the disclosure, the PCF determines the energy usage monitoring based on a Policy included in PCF. According to an embodiment of the disclosure, the PCF distributed, to the SMF, at least one of energy monitoring keys, threshold and configuration, but not limited to.
Step 2: According to an embodiment of the disclosure, the SMF reports energy usage information to the PCF, based on e.g. information from OAM or eNA (3GPP TS 23.288, Network Data Analytics Service (NWDAF)) or some new control plane energy monitoring reporting mechanism, which may take action, e.g. AF notification.
Step 3: According to an embodiment of the disclosure, the PCF may notify, to the AF, notification of energy usage event, or other energy usage, monitoring and/or enforcement related events, but not limited to. Normal AFs can request energy user monitoring info. This is, in the context of the disclosure, not specific or constrained to sponsored connectivity.
New step: reporting energy usage from a means to capture energy usage in the 5G System. This means to capture energy usage is assumed and not specified in the disclosure. Examples OAM, eNA (3GPP TS 23.288, Network Data Analytics Service (NWDAF)), new control plane interfaces and operations could be used to capture energy use.

According to an embodiment of the disclosure, new rules for energy utilization, policy can be enforced by the 5GS. The rules can be captured as part of the subscriber's subscription data, statically or through some other means.

According to an embodiment of the disclosure, new energy utilization monitoring, triggers can be detected by the 5GS and result in notifications to the AF.

According to an embodiment of the disclosure, ‘policy enforcement’ capabilities can be defined.

According to an embodiment of the disclosure, ‘energy utilization metric’ acquisition capabilities can be defined.

According to an embodiment of the disclosure, the energy utilization information that is relevant is not simply something that one can monitor and enforce in one single node (the UPF for QoS Policy), but rather energy utilization information must be gathered from the Radio Access Network (RAN), Core network (CN) and possibly even the UE.

According to an embodiment of the disclosure, the enforcement of the energy policy (e.g. maximum energy utilization rate) can be accomplished by gating or charging (as per QoS Policy) but also by forcing less energy utilization by forcing the UE into a state in which it uses less energy: Service gap controlled operation. The parameters of the service gap can determine how much less energy will be utilized by the 5G system.

### A. Use Case on Service Energy Monitoring by an Application Server (AS)

In SA1 99e, a use case was added to TR 22.882 to enable energy policy to be applied to ‘best effort traffic’ such that service degradations may occur that reduce the effective performance if this saves energy use. The policy defined was to create a ‘maximum energy utilization rate’ that would be applied to the service flow.

This is a use case that elaborates this concept by introducing interaction between the 5G system and an Application Server, so that a service provider can become aware of energy usage. For this kind of traffic (‘best effort with energy constraints’), the mobile network operator can apply constraints introduced here: charging for use of energy or gating upon using more than a maximum energy, which could be a static allowance, or an allowance limited to a period of time (e.g. per day.)

The service provider has an incentive to save energy for their communication that uses a ‘best effort with energy constraints’ policy, to reduce charging or avoid ‘gating’ policy enforcement. Energy information shared with the service provider (via the AS) can lead to adaptation of usage patterns by the service provider at the application layer to e.g. reduce communication in situations where it is more costly, or where the ‘energy credit limit’ approaches. Further, an application service provider can be informed when the energy credit limit has been reached to identify why enforcement prevents further communication through gating (or some other enforcement consequence.)

The use case introduces a means by which a mobile network operator can ‘intelligently pass’ energy costs directly to the customer, provided that this ‘best effort with energy constraints’type of policy is agreed by both parties.

In this scenario, a service provider monitors events resulting from energy utilization policy triggers in the 5G system. These triggers correspond to monitoring policy in the 5G system as well as energy enforcement policies.

FIG. 6 is a schematic diagram of monitoring of energy events by the 5G network for an AS according to an embodiment of the disclosure.

In FIG. 6, the AS obtains information corresponding to the energy consequences of a UE ‘A’served by the 5G network.

This use case will provide a description of a scenario in which the service provider (who operates an application server) cares about energy utilization in the 5G system as a result of the service to UE A. This could be for 3 reasons:
1—the service provider needs to show they are saving energy.
2—the service has an associated energy cost, and the service provider wants to reduce it. This is analogous to the user of industrial or consumer electronics when energy rates are lower, and also as an incentive to operate more efficiently.
3—the service provider recognizes that there are policies that limit energy use (such as aggregate energy use of a slice) and controls the overall use of the service to operate within those constraints.

The use case introduces five new concepts related to new energy events and energy event monitoring:
i) the ability for the network operator to create a ‘maximum energy credit’ policy, after which services are gated, or substantially limited as an enforcement action.
ii) the ability for the network operator to inform an AS of the ‘maximum energy credit expired’event.
iii) the ability for the 5G system to calculate ‘energy credit’ use
iv) the ability to monitor and provide to the AS the use of ‘energy credits’ (or other energy ‘quantum’);
v) the support a new policy that establishes the energy consequence for charging control-either charging for use of energy or establishing an ‘energy credit limit’ for enforcement by the 5G system.

### Pre-Conditions

The UE “A” has a subscription that enables it to make use of ‘best effort communication subject to energy constraints’ policy for communication. This class of communication was introduced in TR 22.882, 5.1.

The application service provider “AS” is capable monitoring service aspects of the 3GPP system, e.g. through network exposure of information as described in 22.261 for QoS monitoring or 22.115 related to credit limit policy and control.

### Service Flows

1. AS is aware that there is an energy policy related to the service for the subscription related to UE “A”. As a result, AS requests to monitor ‘Energy Use’, which is a kind of usage monitoring supported by the 5G system. The monitoring policy has an established ‘threshold’ for the 5G system to notify the AS. In addition, the AS requests to monitor ‘Out of Energy Credit’ events.
2. The 5G system provides service to UE A according to a ‘best effort communication subject to energy constraints’ policy, where the policy charges for energy use and also imposes an ‘energy credit’ limit, after which the UE A subscription is ‘gated’ (receives no further services from the 5G system until more ‘energy credit is available.’ Other enforcement actions are possible, e.g. the subscription receives reduced service, such as a very low maximum bit rate limit is applied.
3. UE A proceeds to use services of the 5G system, especially data communication. As it does so, the charging system is triggered and generates records. The 3GPP charging system uses a means to identify how much credit is used and whether a credit limit is exceeded. The 3GPP charging system in this use case also uses a means of calculating energy credits on the basis of charging events. That is, there is a ‘rating policy’ used to multiply a ‘charging event’by an ‘energy utilization’unit.
NOTE 1: The actual amount of energy corresponding to an ‘energy unit’ used in energy credit control is out of scope of this use case. A mobile network operator can develop a model by which they analyse the total energy needed to provide services and assign fractions of these to each event triggered in the charging system.
4. When the total ‘energy units’ exceed the reporting threshold according to the energy monitoring policy, the 5G system exposes this energy usage information to AS.
NOTE 2: Monitoring of energy usage could be done by other means than ‘energy units’ corresponding to the same units as the credit limit. This could be useful for the third party. However, only by exposing units that result in charging or gating enforcement by the network operator can the third party determine the consequences of their use of services and potentially change their use of those services, e.g. to communicate sparingly, to communicate more efficiently (e.g. at times in less energy use is reported per ‘byte’, etc. of communication, as calculated by the third party based on their own measurements & the monitoring reports of the 5G system.)
5. When the total ‘energy units’ exceed the energy credit limit, this results in the 5G system exposing this event to the AS. The AS could take some action to restore energy credit, but this is out of scope of the use case.

### Post-Conditions

The UE A's use of energy can be monitored by AS. The AS can alter their activity (e.g. communicate less intensely or less frequently) to remain within their expectation be it to keep the charging per energy utilization to their expectation, or to avoid exhausting A's energy credit limit.

The Mobile Network Operator (MNO) is able to create and enforce policies that attach consequences to use of energy. This can lead to energy efficient behaviour on the part of service providers which is both in their interest and the interest of the MNO.

### Existing Feature Partly or Fully Covering Use Case Functionality

The 5G system provides support for credit limits [22.115, 8.2] and for performance monitoring [22.261]. There are a number of other events that are exposed by the 5G system to third parties by the Policy and charging control framework by the 5G System [23.503]. These events and their triggers, which are not detailed in stage 1, allow for usage monitoring to be exposed to a third party in specific circumstances, e.g. sponsored connectivity. The scenario in this use case is similar to sponsored connectivity, as the AS is a directly concerned party that seeks to operate successfully in an efficient manner, as there are charging and even gating consequences as the UE communicates with AS.

Note that the existing usage monitoring and reporting for sponsored connectivity is not sufficient to support this use case because these do not in any way take into account the energy consequence of service. Only traffic volume and time based monitoring are supported today. Other chargeable (and therefore significant events from an energy perspective) are not captured by usage monitoring as supported in the 5G system.

### Potential New Requirements Needed to Support the Use Case

Subject to operator policy, the 5G system shall support subscription policies that define a maximum energy credit limit for services without QoS criteria (also termed “best effort” services.)

Subject to operatory policy, the 5G system shall support subscription policies that define an energy charging rate for services without QoS criteria (also termed “best effort” services.)

Subject to operator policy, the 5G system shall support a means to expose energy utilization to authorized third parties for services such that the energy utilization information clearly identifies the ‘approaching’ enforcement of an energy credit limit.

This exposure of information can be done for any service, including those without QoS criteria (also termed “best effort” services.

Subject to operator policy, the 5G system shall support a mechanism to perform energy utilization credit limit control for services without QoS criteria (also termed “best effort” services.) The result of the credit control is not specified by this requirement. Examples include gating, increased charging rates, etc.

According to an embodiment of the disclosure, the 5G network configured to support one or more subscription policies that define a maximum energy credit limit for services, for example without QoS criteria.

According to an embodiment of the disclosure, the 5G network configured to support one or more subscription policies that define an energy charging rate, for example for services such as without QoS criteria.

According to an embodiment of the disclosure, the 5G network configured to support a mechanism to perform energy utilization credit limit control for services, for example without QoS criteria.

According to an embodiment of the disclosure, the 5G network comprises one or more specific rules to support actions determined by an energy policy; and/or wherein the 5G network is configured to support actions determined by an energy policy according to one or more specific rules.

According to an embodiment of the disclosure, the 5G network comprises a set of trigger events and monitoring policy for supporting energy utilization events, for example according to the needs of the AF; and/or wherein the 5G network is configured to support energy utilization events, for example according to the needs of the AF, according to set of trigger events and monitoring policy for supporting energy utilization events.

According to an embodiment of the disclosure, the 5G network comprises a set of mechanisms, for example as alternatives, to enforce an energy policy; and/or wherein the 5G network is configured to enforce an energy policy according to set of mechanisms, for example as alternatives.

According to an embodiment of the disclosure, the 5G network comprises a set of mechanisms, for example as alternatives, to acquire energy utilization information, for example to which an energy policy and/or a monitoring trigger refers; and/or wherein the 5G network is configured to acquire energy utilization information, for example to which an energy policy and/or a monitoring trigger refers.

According to an embodiment of the disclosure, the 5G network comprises a set of rules for energy utilization and energy policy enforceable by the 5GS; and/or wherein the 5GS is configured to enforce a set of rules for energy utilization and energy policy.

According to an embodiment of the disclosure, the 5G network comprises a service provider configured to monitor events resulting from energy utilization policy triggers in the 5G system.

According to an embodiment of the disclosure, the services have an associated energy cost.

According to an embodiment of the disclosure, the 5G network comprises policies that limit energy use, such as aggregate energy use of a slice, and wherein the 5G network is configured to control use of the services to operate according to these policies.

According to an embodiment of the disclosure, the 5G network is configured to create a maximum energy credit policy, after which services are gated.

According to an embodiment of the disclosure, the 5G network is configured to create a maximum energy credit policy, after which service is reduced, with very low maximum bounds placed on performance.

According to an embodiment of the disclosure, the 5G network is configured to create and/or implement a maximum energy credit policy, after which service is reduced, for example with very low maximum bounds placed on performance.

According to an embodiment of the disclosure, the 5G network is configured to inform an AS of a maximum energy credit expired event.

According to an embodiment of the disclosure, the 5G network is configured to calculate energy credit use.

According to an embodiment of the disclosure, the 5G network is configured to monitor and provide to the AS the use of energy credits.

According to an embodiment of the disclosure, the 5G network is configured to support a policy that establishes an energy consequence for charging control, for example either charging for use of energy or establishing an ‘energy credit limit’ for enforcement by the 5G system.

According to an embodiment of the disclosure, a user equipment, UE, has a subscription enabling the UE to make use of best effort communication subject to energy constraints policy for communication and/or the application service, AS, provider is capable of monitoring service aspects of the 5G network.

According to an embodiment of the disclosure, the application service, AS, is aware that there is an energy policy related to the service for the subscription related to a user equipment, UE, the AS is configured to request to monitor Energy Use, optionally wherein the monitoring policy has an established threshold for the 5G network to notify the AS and/or wherein the AS is configured to monitor Out of Energy Credit events.

According to an embodiment of the disclosure, the 5G network is configured to provide services to a user equipment, UE, according to a best effort communication subject to energy constraints policy, wherein the policy charges for energy use and imposes an ‘energy credit’ limit.

According to an embodiment of the disclosure, the 5G network comprises a charging system including a means of calculating energy credits on the basis of charging events.

According to an embodiment of the disclosure, the application service, AS, is configured to monitor use of energy by the 5G network on behalf of a user equipment, UE.

According to an embodiment of the disclosure, the 5G network is configured to support a means to expose energy utilization to authorized third parties for services, for example without QoS criteria, whereby energy utilization information identifies approaching enforcement of an energy credit limit.

According to an embodiment of the disclosure, the 5G network is configured to support enforcement of subscription policies that define a maximum energy utilization rate for services without associated QoS criteria.

According to an embodiment of the disclosure, the method performed by 5G network include implementing one or more subscription policies that define a maximum energy credit limit for services, for example without QoS criteria.

According to an embodiment of the disclosure, the method includes implementing one or more subscription policies that define an energy charging rate, for example for services such as without QoS criteria.

According to an embodiment of the disclosure, the method includes implementing a mechanism to perform energy utilization credit limit control for services, for example without QoS criteria.

According to an embodiment of the disclosure, the method includes sending, by the PCF sends to the SMF, an energy policy optionally including a limit and/or a parameter.

According to an embodiment of the disclosure, the method includes forwarding, by the SMF to the OCS, the energy policy.

According to an embodiment of the disclosure, the method includes triggering, by the OCS, an event notification and/or trigger according to the energy policy.

According to an embodiment of the disclosure, the method includes sending, by the OCS to the SMF, the event notification and/or trigger for enforcement.

According to an embodiment of the disclosure, the method includes sending, by the SMF to the PCF, the event notification and/or trigger for actioning, for example notifying the AF.

According to an embodiment of the disclosure, the method includes requesting, by the AF, the event notification.

According to an embodiment of the disclosure, the method includes sending, by the PCF to the AF, the event notification.

According to an embodiment of the disclosure, the method includes requesting, by the AF, monitoring of an energy usage event.

According to an embodiment of the disclosure, the method includes storing an energy usage event.

According to an embodiment of the disclosure, the method includes reporting, by the OCF to the SMF, energy usage information, based on the energy policy.

According to an embodiment of the disclosure, the method includes reporting, by the SMF to the PCF, the energy usage information.

According to an embodiment of the disclosure, the method includes optionally, taking, by the PCF, an action.

According to an embodiment of the disclosure, the method includes requesting, by the AF to the PCF, an energy utilization notification.

According to an embodiment of the disclosure, the method includes determining, by the PCF, the energy usage monitoring according to an energy policy and distributing, by the PCF to the SMF, the energy usage monitoring.

According to an embodiment of the disclosure, the method includes reporting, by the SMF to the PCF, energy usage information.

According to an embodiment of the disclosure, the method includes optionally, taking, by the PCF, an action.

According to an embodiment of the disclosure, the method may include transmitting, to a Session Management Function (SMF), an energy policy related to energy credit controlling.

According to an embodiment of the disclosure, the method may include receiving, from the SMF, an event notification.

According to an embodiment of the disclosure, the method may include transmitting, to an Application Function (AF), the event notification.

According to an embodiment of the disclosure, wherein the policy is transmitted from the PCF to Online Charging System (OCS) via the SMF.

According to an embodiment of the disclosure, wherein the event notification is triggered at the OCS and transmitted from the OCS to the PCF via the SMF in case that the OCS identifies that the policy includes energy control policy and aggregate energy cost is larger than energy credit limit based on the policy.

According to an embodiment of the disclosure, in case that the event notification is sent from the OCS to the SMF, a communication session is gated at the SMF by reducing a traffic performance to a low maximum bit rate or triggering User Plane Function (UPF) to stop routing traffic.

According to an embodiment of the disclosure, the method may include receiving, from the AF, an event notification request message.

According to an embodiment of the disclosure, the method may include transmitting, to the AF, the event notification based on the event notification request message.

According to an embodiment of the disclosure, wherein the policy includes at least one of energy charging parameter, energy control parameter, energy credit limit parameter and out of energy credit event trigger parameter.

According to an embodiment of the disclosure, wherein the event notification includes an information related to an energy credit.

According to an embodiment of the disclosure, wherein the aggregate energy cost is obtained at the OCS based on the energy policy and a Policy Charging Control (PCC) rule.

According to an embodiment of the disclosure, a method may include receiving, from an Application Function (AF), a request message related to monitoring of energy usage.

According to an embodiment of the disclosure, the method may include monitoring the energy usage based on an energy policy.

According to an embodiment of the disclosure, the method may include transmitting, to an Online Charging Function (OCF) and a Session Management Function (SMF), a monitoring information related to the energy usage.

According to an embodiment of the disclosure, the method may include receiving, from the SMF, an energy usage information.

According to an embodiment of the disclosure, the method may include transmitting, to the AF, an event notification based on the energy usage information.

According to an embodiment of the disclosure, wherein the energy usage information is transmitted from the OCS to the PCF via the SMF based on the energy policy.

According to an embodiment of the disclosure, the method may include establishing an energy usage threshold based on the monitoring information related to the energy usage.

According to an embodiment of the disclosure, wherein the request message corresponds to the established energy usage threshold.

According to an embodiment of the disclosure, wherein the monitoring information includes at least one of energy monitoring key information, energy monitoring threshold information and energy monitoring configuration information.

According to an embodiment of the disclosure, the method may include receiving, from the SMF, the energy usage information based on transmission information from an Oribtal Angular Momentum (OAM) or an enablers for network automation (eNA).

It will be appreciated by those skilled in the art that various changes and modifications might be made without departing from the scope of the invention, as defined in the appended claims and as described above.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method, performed by a Policy Charging Function (PCF), the method comprising:
transmitting, to a Session Management Function (SMF), an energy policy related to energy credit controlling;
receiving, from the SMF, an event notification; and
transmitting, to an Application Function (AF), the event notification,
wherein the policy is transmitted from the PCF to Online Charging System (OCS) via the SMF, and
wherein the event notification is triggered at the OCS and transmitted from the OCS to the PCF via the SMF in case that the OCS identifies that the policy includes energy control policy and aggregate energy cost is larger than energy credit limit based on the policy.

2. The method of claim 1, wherein, in case that the event notification is sent from the OCS to the SMF, a communication session is gated at the SMF by reducing a traffic performance to a low maximum bit rate or triggering User Plane Function (UPF) to stop routing traffic.

3. The method of claim 1, further comprising:
receiving, from the AF, an event notification request message; and
transmitting, to the AF, the event notification based on the event notification request message.

4. The method of claim 1, wherein the policy includes at least one of energy charging parameter, energy control parameter, energy credit limit parameter and out of energy credit event trigger parameter.

5. The method of claim 1, wherein the event notification includes an information related to an energy credit.

6. The method of claim 1, wherein the aggregate energy cost is obtained at the OCS based on the energy policy and a Policy Charging Control (PCC) rule.

7. A method, performed by a Policy Charging Function (PCF), the method comprising:
receiving, from an Application Function (AF), a request message related to monitoring of energy usage;
monitoring the energy usage based on an energy policy;
transmitting, to an Online Charging Function (OCF) and a Session Management Function (SMF), a monitoring information related to the energy usage;
receiving, from the SMF, an energy usage information; and
transmitting, to the AF, an event notification based on the energy usage information,
wherein the energy usage information is transmitted from the OCS to the PCF via the SMF based on the energy policy.

8. The method of claim 7, further comprising:
establishing an energy usage threshold based on the monitoring information related to the energy usage;
wherein the request message corresponds to the established energy usage threshold.

9. The method of claim 7, wherein the monitoring information includes at least one of energy monitoring key information, energy monitoring threshold information and energy monitoring configuration information.

10. The method of claim 7, wherein receiving the energy usage information further comprising:
receiving, from the SMF, the energy usage information based on transmission information from an Oribtal Angular Momentum (OAM) or an enablers for network automation (eNA).

11. One or more non-transitory computer readable media storing one or more computer programs including computer-executable instructions that, when executed by one or more processors of an electronic device individually or collectively, cause a device to perform operations, the operations comprising:
transmitting, to a Session Management Function (SMF), an energy policy related to energy credit controlling;
receiving, from the SMF, an event notification; and
transmitting, to an Application Function (AF), the event notification,
wherein the policy is transmitted from the PCF to Online Charging System (OCS) via the SMF, and
wherein the event notification is triggered at the OCS and transmitted from the OCS to the PCF via the SMF in case that the OCS identifies that the policy includes energy control policy and aggregate energy cost is larger than energy credit limit based on the policy.
